(19) United States
(12) Patent Application Publication
(10) Pub. No.: US 2024/0034915 A1
(43) Pub. Date: Feb. 1, 2024

(54) Underwater adhesive from dynamic polymers

(71) Applicant: The Board of Trustees of the Leland Stanford Junior University, Stanford, CA (US)

(72) Inventors: Christopher B. Cooper, Palo Alto, CA (US); Zhenan Bao, Stanford, CA (US); Tomoko Nogusa, Yokohama (JP)

(21) Appl. No.: 18/227,826

(22) Filed: Jul. 28, 2023

Related U.S. Application Data
(60) Provisional application No. 63/393,700, filed on Jul. 29, 2022.

(51) Int. Cl. C09J 7/38

(52) U.S. Cl. CPC C09J 7/387; C09J 2301/302; C09J 2203/37; C09J 2471/00; C09J 2483/00; C09J 2409/00

(57) ABSTRACT

Underwater adhesive are provided that include a hydrophobic polymer backbone having periodically embedded dynamic bonding units, where the underwater adhesive has nanophase separation between a first phase of the hydrophobic polymer backbone and a second phase of the dynamic bonding units. The resulting nanophase-separated morphology has clusters of dynamically bonded groups that are protected from water by a surrounding matrix of hydrophobic polymer backbone. This enables a pressure sensitive underwater adhesive with advantages of: no curing needed, reusable, recyclable, and good adhesion strength.

### CROSS REFERENCE TO RELATED APPLICATIONS

This application claims priority from US Provisional Patent Application 63/393,700 filed Jul. 29, 2022, which is incorporated herein by reference.

### GOVERNMENT SPONSORSHIP

This invention was made with Government support under contract W911NF-21-1-0092 awarded by the Department of Defense. The Government has certain rights in the invention.

### FIELD OF THE INVENTION

This invention relates to underwater adhesives.

### BACKGROUND

Adhesives are ubiquitous in everyday life, including both pressure-sensitive adhesives (PSAs) that are activated by pressing the adhesive onto a substrate (e.g., scotch tape or sticky notes) and curable adhesives, which are applied in the liquid state and then cured by air, heat, or light into a solid (e.g., glue or epoxy). In either case, good adhesion strength is achieved by simultaneously maximizing the substrate-adhesive contact area and the cohesive strength of the bulk adhesive material. The former requires the adhesive to readily flow over a surface at accessible timescales while the latter requires sufficient physical or chemical crosslinking to dissipate energy. While conventional adhesives have been well-optimized for dry conditions, most lose adhesion in the presence of water, which is a critical concern for biomedical and structural applications. Underwater adhesives can be loosely classified as moisture-insensitive, water-resistant, or, in the most extreme case, underwater.

Understandably, the design of new synthetic adhesives for underwater use is challenging and has inspired many approaches. In many cases, researchers have adopted bio-inspired designs that use supramolecular or electrostatic interactions based on the underwater adhesion mechanisms of mussels, sand-castle worms, or remoras. An alternative approach is to design strongly hydrophobic self-adhesive materials that can remove interfacial water and maintain bulk cohesive strength by preventing water swelling.

However, these known approaches for underwater adhesives tend to suffer from significant disadvantages, such as requiring a curing step and/or not being pressure-sensitive, reusable and/or recyclable. Accordingly, it would be an advance in the art to provide improved underwater adhesives.

### SUMMARY

Here, we consider dynamic polymers with a hydrophobic backbone to minimize water uptake. The resulting pressure-sensitive adhesives have high adhesion strength and can be applied in fully underwater conditions to polyimide, glass, and steel substrates, without any solvent or covalent crosslinking, at room temperature, and without substrate modifications. Moreover, the polymer adhesive can be readily recycled and reused.

We hypothesized that the tunable structure of dynamic polymers could be used to design simple, solvent-free, hydrophobic PSAs with good underwater adhesion. We show that dynamic polymers which possess physical crosslinking from both supramolecular interactions and topological entanglements could exhibit high cohesive strength while also readily flowing over a surface, thus maximizing adhesive strength. In an example of this work, we embed periodically-placed urethane bonds into a PFPE backbone to create linear dynamic polymers with a nanophase-separated microstructure. We optimize the bonding interactions to tune the rheological properties of the polymers to obtain high strength adhesives and show that the hydrophobicity of PFPE enables underwater adhesion by removing interfacial water and preventing water diffusion into the bulk material. Importantly, these dynamic polymer PSAs can be applied in underwater conditions, at room temperature, without any solvent or curing steps, and can be reused and recycled due to the reversible dynamic crosslinks.

This can also include cases where there is covalent cross-linking of the dynamic polymer (before or after application) as well as the inclusion of other organic or inorganic fillers to modify material properties.

We have shown that combining a hydrophobic backbone with a reversible dynamic bond (e.g., hydrogen bonding, metal-ligand coordination, pi-pi stacking, dynamic covalent bond, etc.) can be used to create strong underwater adhesives. The use of a hydrophobic backbone creates a nanophase-separated morphology, with locally high concentrations of the dynamic bond phase surrounded by a hydrophobic matrix. This matrix prevents water from disrupting the dynamic bond formation, enabling strong underwater adhesion. In addition, the hydrophobic backbone helps remove water from the substrate-adhesive interface. The principles outlined here could be applied to or combined with other types of underwater adhesives such as those that have chemical crosslinking (i.e., curing steps), employ bio-inspired functional groups (e.g., catechols), or contain additives or particles (e.g., composites) to improve performance.

Applications include, but are not limited to biomarine or biomedical applications in which adhesion to wet surfaces is required, especially when this adhesion needs to be repeatedly adhered and de-adhered or the adhesion needs to be done quickly.

Significant advantages are provided:
1) High underwater adhesive strength (0.26 MPa) within an order of magnitude of the best reported underwater adhesives;
2) Rapid and simple application (˜2 s of light pressure) compared to more complex curing methods which require long curing times, organic solvents, elevated temperatures, UV irradiation, oxidative crosslinking, or surface pre-treatments;
3) Reversible adhesion to target substrates that can be repeatedly multiple times in underwater conditions due to the self-healing nature of the PFPE-polymer and the lack of permanent chemical crosslinking during application. This also enables the polymer to be readily recycled.
4) Similar adhesive performance under both dry and underwater conditions.

### BRIEF DESCRIPTION OF THE DRAWINGS

FIG. 1 shows polymer synthesis examples.

FIGS. 2A-E shows characterization results of polymers of this work.

FIG. 2F schematically shows nanophase-separated morphology of polymers of this work.

FIGS. 3A-F show further characterization results of polymers of this work.

FIGS. 4A-C shows adhesive characterization results of this work.

FIG. 5 is a table of measured results for the examples of this work.

FIGS. 6A-B are a comparison of results of the present work (bolded text) to literature reports on underwater adhesives. To aid comparison, the results of the present work are repeated at the top of FIG. 6B

### DETAILED DESCRIPTION

Section A describes general principles relating to embodiments of the invention. Section B is a detailed description of experimental examples of embodiments of the invention.

### A) General Principles

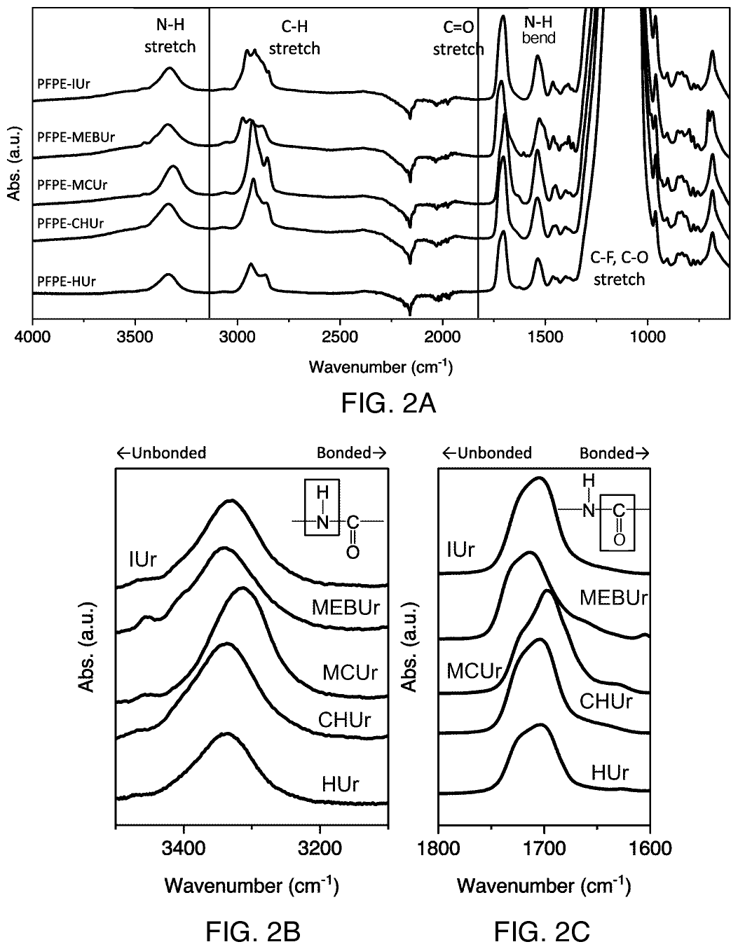

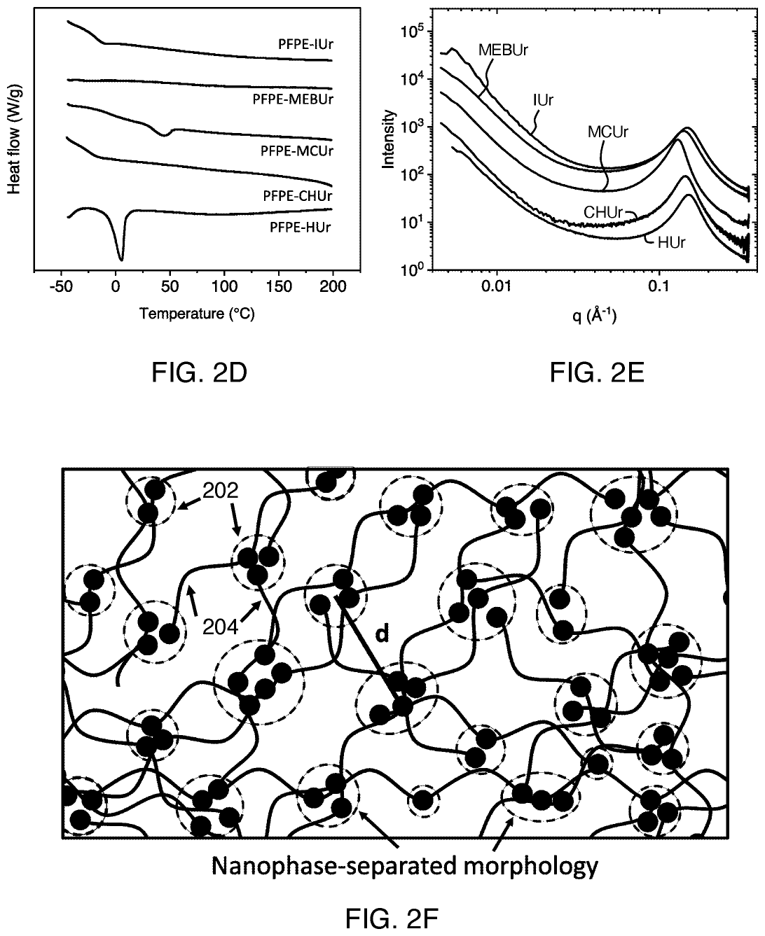

An embodiment of the invention is an underwater adhesive comprising: a hydrophobic polymer backbone having periodically embedded dynamic bonding units; where the underwater adhesive has nanophase separation between a first phase of the hydrophobic polymer backbone and a second phase of the dynamic bonding units (e.g., as shown on FIG. 2F). Here dynamic bonding is chemical bonding that permits structural rearrangement of the bonds in response to low energy external inputs, such as pressure or tension.

The hydrophobic polymer backbone can be selected from the group consisting of: perfluoropolyether, polydimethylsiloxane, polybutadiene, and polyisoprene.

The dynamic bonding units can have a bonding mechanism selected from the group consisting of: hydrogen bonding, metal-ligand coordination, and pi-pi stacking. The dynamic bonding units can be selected from the group consisting of: urethanes, amides, urea, bipyridines, disulfide groups, and catechols.

In some embodiments, the underwater adhesive is pressure sensitive and curing-free. In some cases, the underwater adhesive can be applied when immersed in water. In some cases, the underwater adhesive is reusable.

### B) Specific Examples

### B1) Introduction

Adhesives are ubiquitous in everyday life, including both pressure-sensitive adhesives (PSAs) that are activated by pressing the adhesive onto a substrate (e.g., scotch tape or sticky notes) and curable adhesives, which are applied in the liquid state and then cured by air, heat, or light into a solid (e.g., glue or epoxy). In either case, good adhesion strength is achieved by simultaneously maximizing the substrate-adhesive contact area and the cohesive strength of the bulk adhesive material. The former requires the adhesive to readily flow over a surface at accessible timescales while the latter requires sufficient physical or chemical crosslinking to dissipate energy.

While conventional adhesives have been well-optimized for dry conditions, most lose adhesion in the presence of water, which is a critical concern for biomedical and structural applications. Water interferes with adhesives via two key mechanisms. First, interfacial or boundary layer water can prevent good contact and reduce the available surface area between the substrate and adhesive. Second, water can diffuse into the bulk adhesive material and reduce the overall cohesive strength, either by interfering with physical crosslinks or as a chemically inert plasticizer. Adhesives developed to address these issues can be loosely classified as moisture-insensitive (i.e., adhered in conditions with interfacial water or high humidity), water-resistant (i.e., adhered in dry conditions and used in wet conditions), or, in the most extreme case, underwater (i.e., adhered and used while totally immersed in water). For example, there is a recent report of a moisture-insensitive adhesive for wound care that rapidly adheres to wet or bleeding tissues by removing boundary layer water. Importantly, however, the adhesive must remain totally dry before application, rendering the material unusable in underwater conditions.

Understandably, the design of new synthetic adhesives for underwater use is challenging and has inspired many approaches. In many cases, researchers have adopted bio-inspired designs that use supramolecular or electrostatic interactions based on the underwater adhesion mechanisms of mussels, sand-castle worms, or remoras. For example, many mussel-inspired designs incorporate catechol groups such as dihydroxyphenylalanine (DOPA) to mimic the functional groups present in mussels. Another promising alternative is the use of pre-crosslinked hydrogels, which have been show to reversibly adhere underwater to a variety of substrates through different combinations of supramolecular interactions. Critically, these mechanisms focus on achieving strong adhesion in a state where the adhesive is swollen with water.

An alternative approach is to design strongly hydrophobic self-adhesive materials that can remove interfacial water and maintain bulk cohesive strength by preventing water swelling. Previous work showed that combining hydrophobic poly(N-vinyl caprolactam) (PVCL) with short-molecular weight poly(ethylene glycol) (PEG) created a PSA with high adhesion strength for low water contents, but adhesion failed in conditions when water content exceeded 30 wt %. One report considers crosslinked ionogels with high reversible underwater adhesion strength that are filled with a fluorinated ionic liquid, to prevent water swelling for over 10 days. Another report demonstrated strong underwater adhesion of silicone surfaces using host-guest interactions, but this required pre-functionalization of the surfaces with cucurbituril host and aminomethylferrocene guest moieties. Alternatively, adding hydrophobic aliphatic side chains to polyesters with DOPA functional groups was shown to improve underwater adhesive performance, but required a UV-mediated, chemical crosslinking step. Finally, poly(catechol-styrene) polymers have shown exceptionally strong underwater adhesion but must be pre-dissolved in chloroform when applied to the substrate and cured for 24 hours before testing.

We hypothesized that the tunable structure of dynamic polymers could be used to design simple, solvent-free, hydrophobic PSAs with good underwater adhesion. Previous work has shown that long-chain, entangled polymers can dramatically improve adhesive strength of hydrogels by increasing bulk cohesive strength and preventing delamination or fracture at the interface. Similarly, we theorized that dynamic polymers which possess physical crosslinking from both supramolecular interactions and topological entanglements could exhibit high cohesive strength while also readily flowing over a surface. Moreover, our recent work has shown that dynamic polymers with evenly-spaced dynamic bonds along their backbone, termed periodic dynamic polymers, can exhibit well-defined supramolecular structures, which could improve nanophase separation between the backbones and the dynamic bonds and thus limit bulk water diffusion. For a hydrophobic backbone, we selected perfluoropolyether (PFPE) due to its high chain flexibility, low glass transition temperature, and excellent solvent resistance. PFPE-based dynamic polymers have been used for many applications including antifouling coatings or electrode coatings in batteries. Supramolecular telechelic PFPE polymers with 2-ureido-4[1H]-pyrimidone (Upy) end groups, PFPE-based vitrimers, and crosslinked PFPE polyurethanes have been previously reported but only exhibit terminal flow at or above 100° C., rendering them unsuitable for use as adhesives.

In this work, we embed periodically-placed urethane bonds into a PFPE backbone to create linear periodic dynamic polymers with a nanophase-separated microstructure. We optimize the bonding interactions to tune the rheological properties of the polymers to obtain high strength adhesives and show that the hydrophobicity of PFPE enables underwater adhesion by removing interfacial water and preventing water diffusion into the bulk material. Importantly, these dynamic polymer PSAs can be applied in underwater conditions to a variety of substrates, at room temperature, without any solvent or curing steps, and due to their reversible dynamic crosslinks they can be easily removed and reapplied without additional stimuli and readily recovered and recycled after use.

### B2) Results and Discussion

### B2a) Design and Synthesis of PFPE-Based Dynamic Polymers

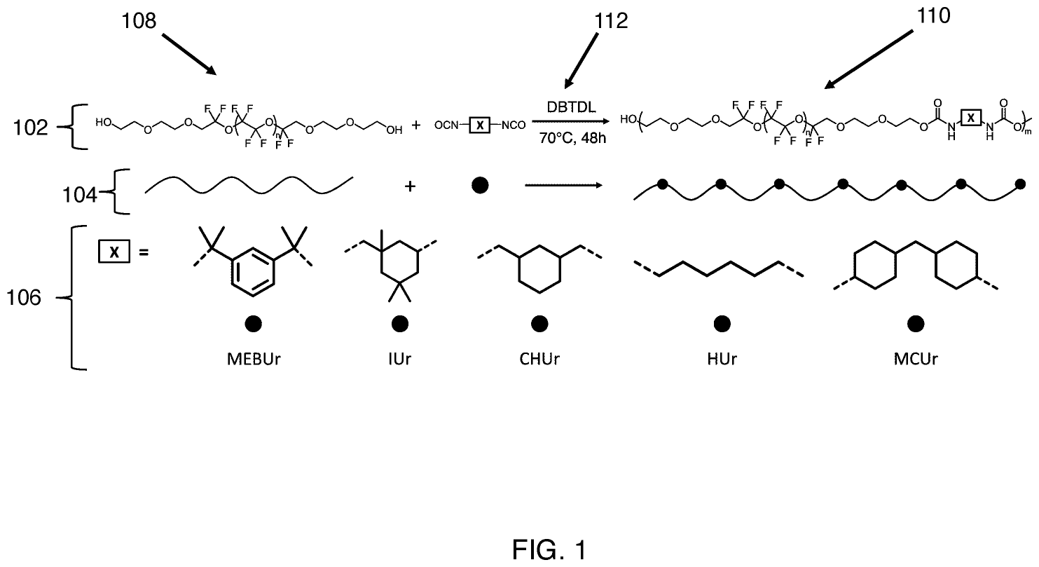

FIG. 1 shows synthesis of PFPE-based dynamic polymers. Here 102 shows Diol-terminated PFPE oligomers 108 reacted (112) with various diisocyanates (X-block) to form dynamic PFPE-polymers 110 with evenly-spaced urethane bonds of different geometries along the backbone. 104 schematically shows the effect of this reaction is to provide periodic urethane bonding groups (black circles) along the polymer backbone. Here 106 shows the five different liquid diisocyanates that were investigated, including 1,3-bis(1-isocyanato-1-methylethyl)benzene (MEBUr), isophorone diisocyanate (IUr), 1,3-bis(isocyanatomethyl)cyclohexane (CHUr), hexamethylene diisocyanate (HUr), and 4,4′-methylenebis(cyclohexyl isocyanate) (MCUr).

We synthesized the PFPE-based dynamic polymers using a solvent-free reaction between an initial PFPE-diol 1700 g/mol, FluorolinkE10-H) and various liquid diisocyanates (FIG. 1). This procedure allows for periodic placement of the dynamic hydrogen bonding groups along the PFPE backbone, which has been shown to influence film microstructure and bond clustering. In total, we synthesized five different polymers from five diisocyanates: 4,4′-Methylenebis(cyclohexyl isocyanate) (PFPE-MCUr), 1,3-Bis(1-isocyanato-1-methylethyl)benzene (PFPE-MEBUr), isophorone diisocyanate (PFPE-IUr), Hexamethylene diisocyanate (PFPE-HUr) and 1,3-Bis(isocyanatomethyl)cyclohexane (PFPE-CHUr).

FIGS. 2A-F show characterization of PFPE-based dynamic polymers. FIG. 2A shows FT-IR spectra of PFPE-IUr, PFPE-MEBUr, PFPE-MCUr, PFPE-CHUr, and PFPE-HUr vertically offset for clarity. FIGS. 2B and 2C show zoomed-in regions of the FTIR spectra showing differences in the N—H stretch and C═O stretch, respectively, of the urethane bonds for different PFPE polymers. FIG. 2D shows DSC curves for PFPE-IUr, PFPE-MEBUr, PFPE-MCUr, PFPE-CHUr, and PFPE-HUr vertically offset for clarity. FIG. 2E shows SAXS data for PFPE-IUr, PFPE-MEBUr, PFPE-MCUr, PFPE-CHUr, and PFPE-HUr showing a nanophase-separated morphology between 4-5 nm. FIG. 2F is a schematic of nanophase-separated morphology of the PFPE-based polymers, created by clustered regions 202 of dynamic bonds (dashed circles) surrounded by a matrix of backbone polymer 204. The domain size (d) is the average distance between clusters of dynamic bonds and corresponds to the SAXS peak.

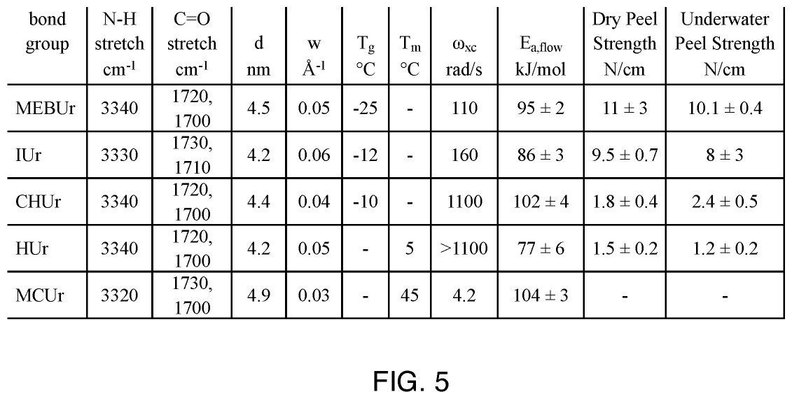

We confirmed the successful polymerization by ¹H-NMR and Fourier-transform infrared spectroscopy (FTIR) analysis (FIGS. 2A-C). The disappearance of the isocyanate absorption band (˜2260 cm⁻¹) and the emergence of the N—H stretch (˜3330 cm⁻¹) and C═O stretch (1710 cm⁻¹) suggest the formation of urethane bonds. FTIR also allowed us to compare the degree of hydrogen bonding between the various dynamic bonds by comparing the relative shifts in the N—H stretch and C═O stretch (FIGS. 2B-C, FIG. 5). PFPE-MCUr exhibited a noticeably higher degree of hydrogen bonding (shifted to lower wavenumbers) compared to the other PFPE-based polymers. This finding was further supported by DSC data (FIG. 2D), which shows that PFPE-MCUr displays a melting peak (Tₘ) at 45° C. (1.4 J/g), suggesting that the hydrogen bonds are well-packed into a partially crystalline structure. PFPE-HUr also exhibits a notable melting peak at 5° C. (5.9 J/g). However, at room temperature almost all the crystalline structures have melted. Interestingly, PFPE-CHUr, PFPE-IUr, and PFPE-MEBUr do not exhibit any melting peaks but instead show a broad glass transition (T_{g}) between −25° C. and −10° C., suggesting a more amorphous packing of the dynamic bonds.

### B2b) Microstructural and Rheological Characterization

We also characterized the microstructure of the polymers by small-angle x-ray scattering (SAXS). All polymers exhibited a single, characteristic peak corresponding to a domain size (d) between 4-5 nm (FIG. 2E, FIG. 5). As the scattering contrast in the system predominantly arises from the electron density contrast between the PFPE backbone and the dynamic bond, this peak is characteristic of the average distance between individual or aggregated dynamic bonds, as illustrated in FIG. 2F. This type of nanophase-separated morphology has been linked to improved mechanical properties in polyureas and polyurethanes. PFPE-MCUr had a significantly larger size of 4.9 nm compared to 4.2-4.5 nm for the other polymers as well as a smaller full width at half maximum (w) of 0.03 Å⁻¹ compared to 0.04-0.06 Å⁻¹ (FIG. 5). Given that the concentration of dynamic bonds is approximately the same for all polymers (i.e., constant backbone molecular weight between each bond), an increased average distance between dynamic bonds implies an increase in the average size of aggregated bonding domains. This is consistent with the explanation of the FTIR and DSC data that PFPE-MCUr displays a higher degree of well-ordered hydrogen bonding domains. It is important to note that all of the peaks are broad and thus, this domain size is an average over many different inter-cluster distances. Water contact angle measurements confirm the hydrophobicity of all the PFPE-based polymers, with values between 103-109°, which provides additional evidence that the polar hydrogen bonding groups are clustered interiorly instead of accumulating on the surface.

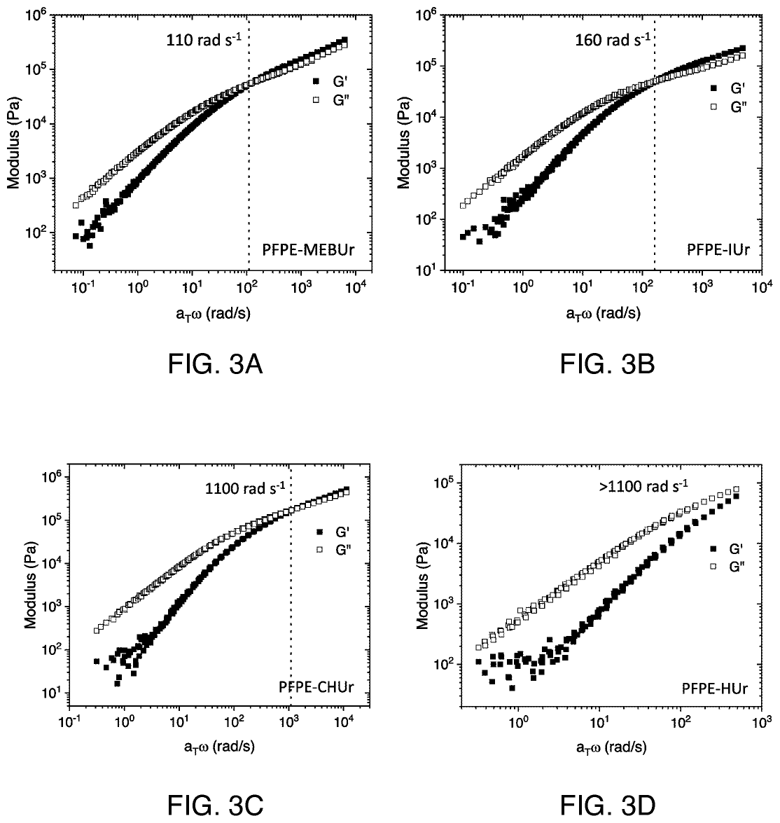

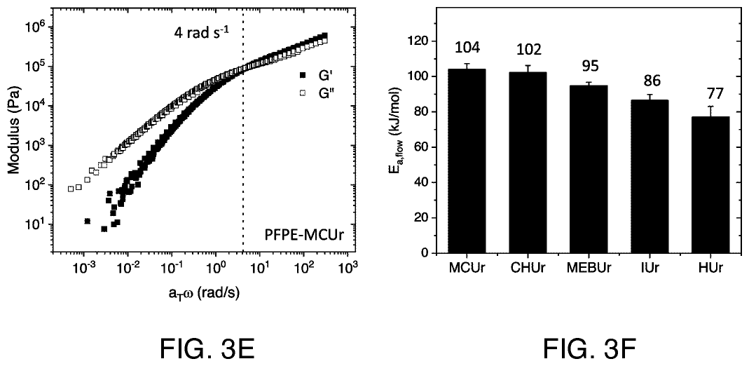

FIGS. 3A-F show rheological properties of the PFPE-based polymers. Master curves at 55° C. are constructed from time-temperature superposition showing the storage moduli (G′, solid squares) and loss moduli (G″, open squares) for (FIG. 3A) PFPE MEBUr, (FIG. 3B) PFPE-IUr, (FIG. 3C) PFPE-CHUr, (FIG. 3D) PFPE-HUr, and (FIG. 3E) PFPE-MCUr. The G′, G″ crossover for each master curve is marked with a dashed vertical line. FIG. 3F shows measured flow activation energies for all polymers determined from the shift factor temperature dependence.

We next characterized the rheological properties of the different PFPE polymers by performing frequency sweeps at various temperatures and performing time-temperature superposition (TTS). The resulting master curves at 55° C. for each polymer are plotted in FIGS. 3A-E. For PFPE-MCUr and PFPE-HUr, only temperatures above the melting point are used to create the master curve, since significant changes to the material microstructure occur during melting and invalidate the single-temperature dependence assumption required for TTS. All of the polymers exhibit a crossover frequency (ω_{xc}) between the storage modulus (G′) and the loss modulus (G″) between 4.2-1100 rad s′ and show terminal flow behavior at low frequency with G″ ˜ω and G′˜ω^{1.3-2}, related to a combination of hydrogen bond dissociation and polymer disentanglement that enables single-chain diffusion.

Plotting the shift factors for various temperatures shows a clear Arrhenius temperature dependence, which allows for the estimation of the flow activation energy (E_{a,flow}) for each polymer (FIG. 3F, FIG. 5). A general trend in activation energy from 80-120 kJ/mol is observed with MCUr˜CHUr>MEBUr>IUr>HUr. Assuming that all of the polymers have a similar microstructure above 55° C., E_{a,flow} is generally assumed to indicate the relative strength between the different hydrogen bonding units. With the exception of PFPE-CHUr, the trend observed in E_{a,flow} is similar to the trend observed in ω_{xc} with MCUr<MEBUr<IUr<CHUr<HUr. In general, we expect that for materials with similar microstructure, stronger bonds should lead to slower relaxation dynamics and thus high E_{a,flow} should correlate to low ω_{xc}. A potential explanation could be the ability of CHUr to form intramolecular bonds that increase the bond strength without slowing network relaxation dynamics. Broadly, these data are consistent with the SAXS results showing a similar nanophase separated morphology in all the polymers, with the differences in their rheological properties governed by differences in the dynamic bond strength.

### B2c) Adhesive Properties of PFPE-Based Dynamic Polymers

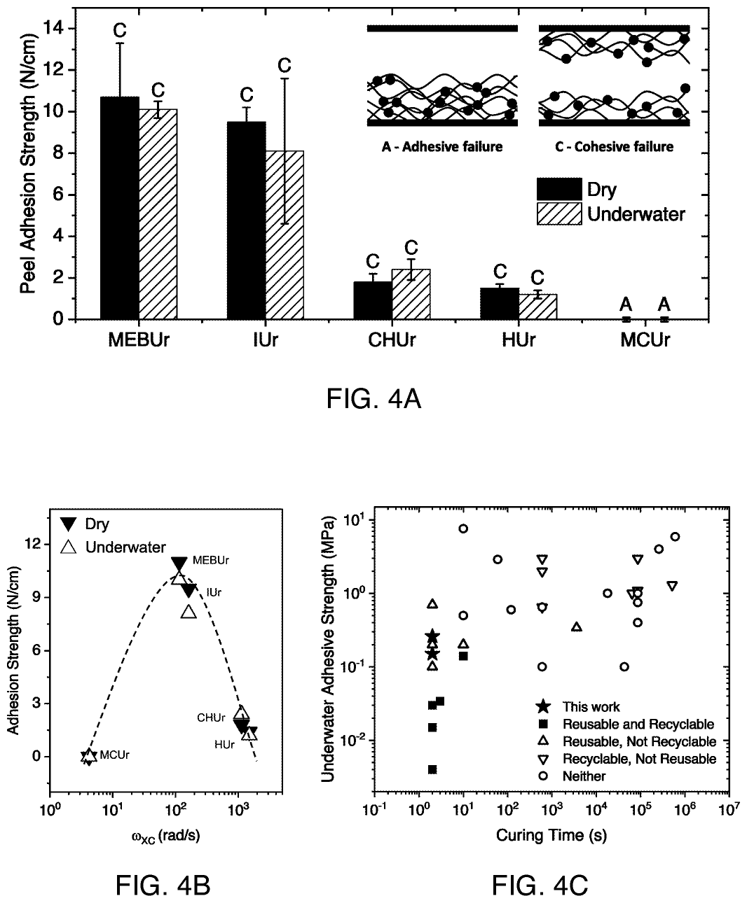

FIGS. 4A-C show adhesive performance of the PFPE-based polymers. FIG. 4A shows peel adhesion strength under dry (solid) and underwater (striped) conditions for PFPE-MEBUr, PFPE-IUr, PFPE-CHUr, PFPE-HUr, and PFPE-MCUr. Each bar is marked by whether the adhesive failure was cohesive (C) or adhesive (A), as shown by the inset (n=3). FIG. 4B is a comparison of G′, G″ crossover frequency with measured peel adhesive strength on Kapton for both dry (solid triangles) and underwater (open triangles) conditions for PFPE-MEBUr, PFPE-IUr, PFPE-CHUr, PFPE-HUr, and PFPE-MCUr. FIG. 4C is a literature comparison plotting the curing time versus the underwater adhesive strength of previously reported adhesives measured by lap shear tests. Each adhesive is classified based on whether it is reusable (i.e., able to be reversibly adhered and de-adhered underwater without additional stimuli) or recyclable (i.e., able to be recovered or re-dissolved after use and re-processed into a new adhesive). Adhesives are grouped as both reusable and recyclable (solid squares), reusable but not recyclable (up triangles), recyclable but not reusable (down triangles), or neither reusable or reversible (circles). The polymers presented in this work (PFPE-MEBUr and PFPE-IUr) are marked as solid stars and are both reusable and recyclable.

To characterize the adhesive properties of the various polymers, we performed 180° peel tests on pressed Kapton films prepared using a weighted hand roller. After each test, we inspected each sample to determine whether the failure mechanism was adhesive (i.e., polymer intact and separated from the substrate) or cohesive (i.e., polymer remains adhered to the substrate and breaks in the bulk). PFPE-MEBUr and PFPE-IUr exhibited the best dry adhesion strength of 11 and 9.5 N/cm, respectively (FIG. 4A, FIG. 5). These values are comparable to commercial dry adhesives, such as double-sided tape or aluminum tape, which have peel strengths between 1-10 N/cm. Alternatively, PFPE-CHUr and PFPE-HUr had adhesion strengths of 1.8 N/cm and 1.4 N/cm, while PFPE-MCUr did not show any significant adhesion. All polymers except PFPE-MCUr exhibited cohesive failure. The lack of adhesion in PFPE-MCUr, despite it having the strongest bond strength and mechanical properties, is attributed to its inability to wet the substrate interface due to its low crossover frequency (ω_{xc}) and suggests that stronger bonds do not always result in stronger adhesion.

When comparing these adhesion results to the structural and rheological characterization of the polymers presented above, we show that the dominant molecular design principle related to the adhesive strength of the polymer is tuning the G′, G″ crossover frequency (ω_{xc}). This is consistent with the goal of balancing the cohesive strength or bulk energy dissipation of the adhesive with the ability for the adhesive to spread over the substrate, which increases surface area. The same mechanism is seen in how spiders tune glue viscosity to maximize adhesion strength. In our case, PFPE-MCUr, which exhibits the strongest hydrogen bonding and has the largest cohesive strength but its low ω_{xc} means that it is unable to sufficiently spread over the surface for good adhesion. Alternatively, PFPE-CHUr and PFPE-HUr have high ω_{xc} and can easily flow over the surface and maximize surface area, but this reduces their cohesive strength. Thus, PFPE-MEBUr and PFPE-IUr have a ω_{xc} which enables them to efficiently maximize surface contact while maintaining high cohesion strength. This relationship can be seen by plotting adhesion strength versus ω_{xc} for all of the polymers (FIG. 4B).

To study the underwater adhesion of the polymers, we conducted 180° peel tests of the polymers when fully immersed in water before and after contact with the substrate. Due to the hydrophobic nature of the PFPE backbone combined with the nanophase-separated morphology, we hypothesized that the PFPE would shield the hydrogen bonds from water and enable underwater substrate adhesion. Indeed, all the polymers maintained ˜90% of their dry adhesion strength under wet conditions (100% when considering measurement error), with PFPE-MEBUr and PFPE-IUr exhibiting the highest underwater adhesion strengths of and 8 N/cm, respectively (FIG. 4B, FIG. 5). This highlights a key advantage of employing a tunable dynamic bond system, which allows us to optimize ω_{xc} to improve adhesion strength by changing the bond geometry while maintaining a similar polymer architecture and nanophase separated morphology to ensure good underwater performance. These dynamic PFPE adhesives dramatically outperformed commercial Scotch tape, which exhibited a dry peel strength of 0.7 N/cm and an underwater peel strength of 0.3 N/cm (less than 50% of its dry adhesive strength). Moreover, when soaked for 24 hours underwater before testing, PFPE-MEBUr and PFPE-IUr maintained high peel strengths of 5.4±2.9 and 5.7±1.4 N/cm. Both polymers also exhibited high adhesive strength when tested in water with 1M NaCl as well as at different pH values. The use of dynamic crosslinking (as opposed to covalent crosslinking) also allows the PFPE-based underwater adhesives reported here to be readily recycled by extracting the polymer from used adhesive strips. Recycled PFPE-MEBUr retains similar performance to the pristine polymer, with a dry adhesion strength of 8.1±1.3 N/cm. Alternatively, the used adhesive can be mechanically separated from the substrate and re-annealed on a new substrate to prepare a new adhesive to avoid using solvent during the recycling process (but at lower recovered yields), analogous to the preparation of samples from the bulk synthesized polymer.

We also tested the adhesion strength of PFPE-MEBUr and PFPE-IUr on different substrates. We saw similarly strong adhesion strength on steel for both polymers under dry conditions (˜11 N/cm). When tested underwater, PFPE-MEBUr and PFPE-IUr retained 70% and 50% of their dry adhesion strength, respectively, which was slightly lower than observed when adhering to Kapton film. Both PFPE-MEBUr and PFPE-IUr exhibited reduced dry and wet adhesion to high-density polyethylene, which has a much lower surface energy (˜34 mJ/m²) compared to Kapton (˜57 mJ/m²) or steel (˜50 mJ/m²). Further optimization to improve substrate-specific adhesion is an area for future study.

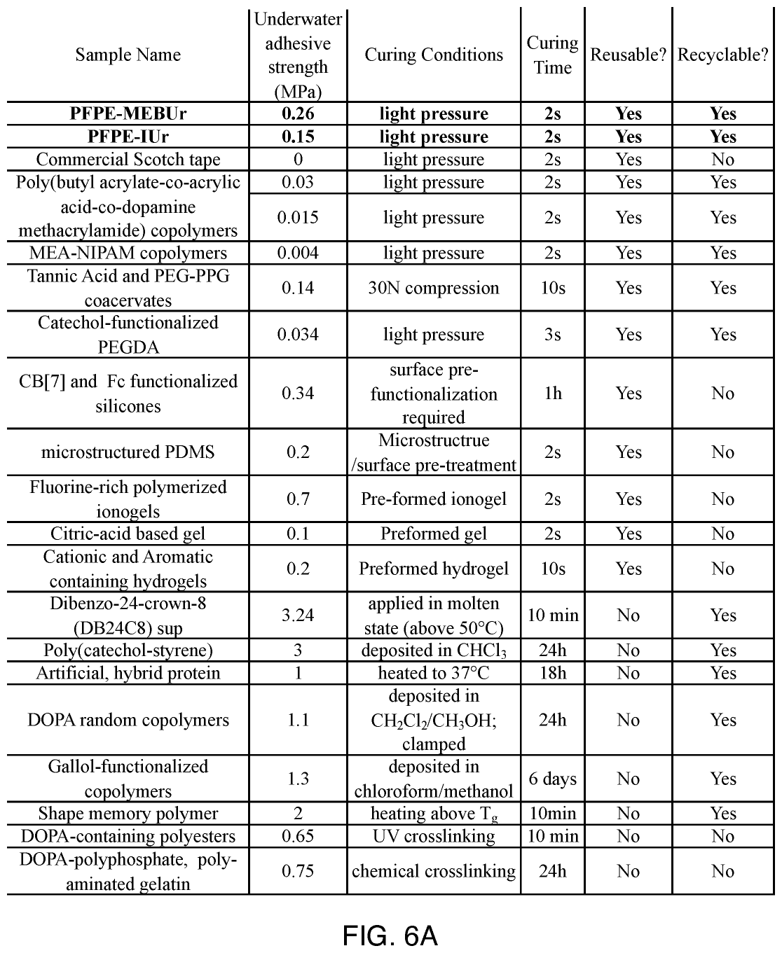

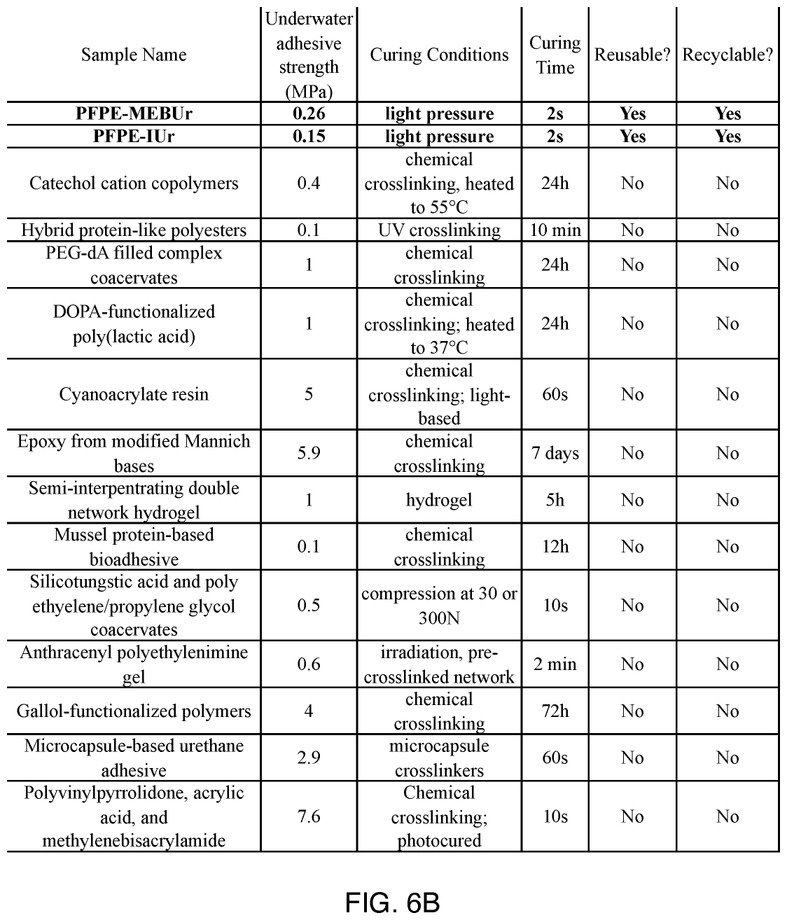

To make a comparison to a broader range of developed underwater adhesives, we next performed dry and underwater lap shear tests for both PFPE-MEBUr and PFPE-IUr. These results are presented in FIGS. 6A-B alongside data from previously developed underwater adhesives on a range of substrates reported in the literature. Compared to previously developed adhesives, the PFPE-based adhesives demonstrated here possess a unique combination of:
High underwater adhesive strength (0.26 MPa)
Rapid and simple application (˜2 s of light pressure) compared to more complex curing methods which require long curing times, organic solvents, elevated temperatures, UV irradiation, oxidative crosslinking, or surface pre-treatments
Reversible adhesion to target substrates that can be repeatedly multiple times in underwater conditions due to the self-healing nature of the PFPE-polymer (i.e., reusable)
Recyclability due to the lack of permanent chemical crosslinking during application, which allows the polymer to be dissolved and recovered from used adhesive strips (i.e., recyclable)
Similar adhesive performance under both dry and underwater conditions

We summarized this comparison in FIG. 4C, which plots the required curing time of different adhesives versus their obtained underwater adhesive strength. For each literature reference, we selected the best reported value to use for adhesive strength, regardless of substrate or testing conditions. We plotted them on a log-scale plot, which means that even a 2× change in value due to substrate effects is unlikely to affect the observed trends. Additionally, we classify each adhesive based on if it can be reversibly adhered and de-adhered underwater without additional stimuli (i.e., reusability) or if it can be recycled. FIG. 4C highlights the advantages of the PFPE-based dynamic polymers reported in this work—their combination of high underwater adhesive strength, reusability, and recyclability. While other adhesives have been reported with higher strengths, they often involve significantly longer curing times and solidification or chemical crosslinking which prevents their re-use or recyclability. On the other hand, other recyclable and reusable adhesives with short curing times often have low overall strength.

Lastly, we demonstrated the underwater adhesive properties of PFPE-MEBUr by lifting fishing weights of different sizes using a small amount of adhesive placed on the fingertip. A single adhesive application of a gloved fingertip (˜1 cm², 50 mg) was able to repeatedly lift a 10 g, and 60 g weight all while continuously adhering and de-adhering underwater. Importantly, since the material is a PSA, no curing step was needed and re-adhesion could be easily achieved in a few seconds by re-applying pressure between the glove and the weight. We also show that the weights can be lifted out of the water and remain adhered to the finger. Finally, we compared the underwater adhesion performance of PFPE-MEBUr to commercial double-sided tape, which fails to adhere to either the fishing weight or Kapton film.

### B3) Conclusion

In this work, we report the successful synthesis of a series of PFPE-based dynamic polymers with periodically-placed hydrogen bonding units. The synthesis is simple, scalable, and solvent-free. We show that changes in the dynamic bond can tune the rheological behavior of the samples by changing the bond strength, while periodic placement of these bonds along the PFPE backbone ensures the formation of a nanophase-separated morphology for all bond types as shown by SAXS. We evaluate the adhesion capability of all synthesized PFPE dynamic polymers and find that PFPE-MEBUr and PFPE-IUr show the best adhesive performance up to 11 N/cm under dry conditions. We show that this strong performance arises from optimizing the rheological crossover point (ω_{xc}) and note that this point varies across the polymers due to changes in the molecular level bonding geometry of the selected dynamic bonds. Due to the hydrophobic nature of the PFPE backbone, all the polymers retain more than 90% of their dry adhesion strength in underwater conditions, leading to an achieved underwater adhesive peel strength of 10 N/cm and underwater lap shear strength of 0.26 MPa for the best performing polymer, PFPE-MEBUr.

Our results show that careful control of the G′ and G″ crossover frequency (ω_{xc}) is preferred to optimize the adhesive strength of the polymers. We achieve this control by controlling the molecular geometry of the dynamic bonding unit along the PFPE backbone without changing the chain architecture (e.g., bond concentration, bond spacing, or chain length), which is responsible for maintaining the nanophase-separated morphology. More broadly, this work shows how dynamic polymers with tunable structures and properties are a promising platform to design materials for specific functional applications such as high strength, recyclable underwater adhesives. These adhesives could be used to enable readily attachable and detachable waterproof wearable devices that are also fully recyclable.

### B4) Experimental Procedures

### B4a) Materials

Diol-terminated perfluoropolyether (PFPE) oligomers (Fluorolink® E10-H, Mₙ=1.7 kDa) were purchased from Solvay (Belgium). Various diisocyanates, including 4,4′-methylenebis(cyclohexyl isocyanate) (MCUr), 1,3-bis(1-isocyanato-1-methylethyl)benzene (MEBUr), isophorone diisocyanate (IUr), hexamethylene diisocyanate (HUr) and 1,3-bis(isocyanatomethyl)cyclohexane (CHUr) were purchased from Sigma-Aldrich (USA). All reagents and solvents were commercially available and used without further purification.

### B4b) Synthesis of PFPE-Based Polymers

This procedure was adapted from a previous report. PFPE-diol (Mₙ≈1700 g/mol, FluorolinkE10-H, 2 g.) was placed at 90° C. under vacuum for 2 hours to remove trace water. The selected diisocyanate was added in a 1:1.05 molar ratio of alcohol/isocyanate functional groups and stirred vigorously. The flask was placed under vacuum for 5 min, then flushed with N₂. This process was repeated 3 times. Dibutyltin dilaurate (DBDTL, 1-2 drops) was added as a catalyst then the mixture was heated to 70° C. for 48 hours. Compared to the previous report at 125° C., we found that a lower reaction temperature of 70° C. reduced sample discoloration and prevented crosslinking of the isocyanate into a trimer, while still fully reacting all isocyanate groups (as seen by FTIR). The mixture was solidified after 48 hours. The reacted mixture was cooled to room temperature, dissolved in 8 mL of 2,2,2-trifluoroethanol (TFE), precipitated from dichloromethane (DCM), and dried. The final product was a clear, highly transparent, sticky polymer.

### B4c) Nuclear Magnetic Resonance Spectroscopy (NMR)

¹H NMR data were obtained on a Varian 400 MHz spectrometer with trifluoroacetic acid-d as the solvent at room temperature. Tetramethylsilane (TMS) was used as the standard, with chemical shifts reported in 5 (ppm downfield from TMS).

### B4d) FT-IR Spectroscopy

ATR-FTIR (attenuated total reflection-Fourier Transform InfraRed) spectra were recorded using a Nicolet iS50 with a diamond attenuated total reflectance attachment. The polymer samples were placed directly on the sample stage and measured in air.

### B4e) Rheological Characterization Methods

Dynamic mechanical analyses were conducted using an Ares G2 Rheometer with an 8 mm parallel plate set-up in a temperature-controlled convection oven. Samples were placed on 8 mm diameter discs. Frequency sweep tests were collected from 100 rad/s to 0.1 rad/s at designated temperatures with an applied strain of 1% under an axial force of 0.02N. Temperature sweeps were performed in 10° C. steps with a wait time of 180 s between steps to allow the sample temperature to equilibrate. Time-temperature superposition (TTS) was executed in Trios software when appropriate (as deemed by successful overlap in G′, G″, and tan(5) for all shifted samples). To ensure full contact between the sample and the plates, a pre-conditioning step was used, in which the sample was heated above 100° C. and a frequency sweep was performed from 100 rad/s to 0.1 rad/s under a compressive force between 0.05-2N.

### B4f) Differential Scanning Calorimetry

Differential scanning calorimetry (DSC) was conducted using a TA instruments Q2000 DSC. Approximately 10 mg of polymer were placed in sealed aluminum pans. Samples were ramped from −50° C. to 150° C. at a rate of 10° C./min. Glass transition and melting temperatures were extracted using TA Universal Analysis software.

B4 g) Small-Angle x-Ray Scattering Methods

Small-angle x-ray scattering (SAXS) was conducted in transmission mode on bulk polymer films at beamline 4-2 at Stanford Synchrotron Radiation Light source (SSRL) of SLAC National Accelerator Laboratory (SLAC, Menlo Park, CA). Bulk polymer films were tested as free-standing films with a thickness of ˜0.1 mm. The x-ray wavelength was 0.827 Å (beam energy 15 keV) with a sample-to-detector distance of 3.512 m. The Pilatus 1M fast detector was used for 2D scattering data acquisition and reduction into scattering intensity profiles as a function of the scattering vector q was done using customized code at the beamline. For each sample, 10 frames of 1 second exposure were averaged to improve the signal-to-noise ratio. Measurements were performed in ambient air.

### B4h) Contact Angle Measurements

Contact angle measurements with water were performed on a custom set-up in ambient conditions at room temperature. Fresh films of each polymer were prepared by dropcasting from 2,2,2-trifluroroethanol (100 mg/mL), evaporating under a covered petri dish overnight, and heating at 70° C. for 24 hours. Contact angle images were analyzed with First Ten Angstroms (FTA) software.

### B4i) Dry Adhesion 180° Peel Test

The adhesive properties of the PFPE polymers were measured by a 180° peel test at room temperature at a peel rate of 300 ram/min. The polymers were placed on 10 mm stripe of Kapton sheet and heated on 70° C. for 24 hours to anneal a square film with a thickness of ˜0.1 mm. Kapton, steel and high-density polyethylene (HDPE) was used as a test substrate. The polymer was adhered onto the test substrates using a 2 kg hand roller rolled twice in each direction at approximately 10 mm/s. The test samples were stored in ambient conditions for 1 hour before testing. The end of the tape was pulled back at 180°, mounted in an Instron 5565 extensometer, and pulled at 300 ram/min. Peel tests were repeated three times, and the results were averaged.

### B4j) Underwater Adhesion 180° Peel Test

The polymers were placed on 10 mm stripe of Kapton sheet and heated on 70° C. for 24 hours to anneal a square film with a thickness of ˜0.1 mm. The underwater adhesive properties of the PFPE polymers were measured by first immersing the polymers and substrates in deionized water for 1 hour. Contact between the adhesive and the substrate was made underwater by light pressing. A 2 kg hand roller was then rolled over the sample twice in each direction at approximately 10 mm/s. The adhered sample was then continually immersed in water for another hour. Finally, the sample was then immediately mounted onto the Instron 5565 extensometer for the peel adhesion test, conducted at room temperature at a peel rate of 300 ram/min. Peel tests were repeated three times, and the results were averaged.

### B4k) Dry Lap Shear Adhesion Tests

The polymers were placed on 10 mm stripe of Kapton-covered glass slide and heated on 70° C. for 24 hours. Another Kapton slide was placed on top of the first and lightly pressed to form a lap shear joint. Samples were measured on an Instron 5565 extensometer and pulled apart at a measurements speed of 600 ram/min. The maximum force at joint failure divided by the overlap area provided the adhesion strength. Each sample was tested a minimum of three times and averaged. Double-sided scotch tape was tested in the same manner, by adhering between two Kapton-covered glass slides.

### B4l) Underwater Lap Shear Adhesion Tests

For underwater lap shear adhesion tests, the polymer-coated Kapton slide and the fresh Kapton slide were placed underwater for 1 hour. The samples were joined underwater by lightly pressing them together and then remained submerged underwater for another hour. Samples were then tested on an Instron 5565 extensometer. Each sample was tested a minimum of three times and averaged. Double-sided scotch tape was tested in the same manner, by adhering between two Kapton-covered glass slides.

### B4m) Statistical Analysis

Each adhesion test (peel or lap shear) was measured three times for each sample (n=3) and the error was determined by the sample standard deviation between the measurements. No pre-processing of the data or advanced statistical methods were used.

1. An underwater adhesive comprising:
a hydrophobic polymer backbone having periodically embedded dynamic bonding units;
wherein the underwater adhesive has nanophase separation between a first phase of the hydrophobic polymer backbone and a second phase of the dynamic bonding units.

2. The underwater adhesive of claim 1, wherein the hydrophobic polymer backbone is selected from the group consisting of: perfluoropolyether, polydimethylsiloxane, polybutadiene, and polyisoprene.

3. The underwater adhesive of claim 1, wherein the dynamic bonding units have a bonding mechanism selected from the group consisting of: hydrogen bonding, metal-ligand coordination, and pi-pi stacking.

4. The underwater adhesive of claim 1, wherein the dynamic bonding units are selected from the group consisting of: urethanes, amides, urea, bipyridines, disulfide groups, and catechols.

5. The underwater adhesive of claim 1, wherein the underwater adhesive is pressure sensitive and curing-free.

6. The underwater adhesive of claim 1, wherein the underwater adhesive can be applied when immersed in water.

7. The underwater adhesive of claim 1, wherein the underwater adhesive is reusable.

8. The underwater adhesive of claim 1, wherein the nanophase separation results in a configuration of dynamic bond clusters that are protected from water by a surrounding matrix of the hydrophobic polymer backbone.
